(19) United States
(12) Patent Application Publication
(10) Pub. No.: US 2012/0162034 A1
(43) Pub. Date: Jun. 28, 2012

(54) METHOD AND APPARATUS FOR INTEGRATING A WIRELESS COMMUNICATIONS DEVICE INTO A STREETLIGHT FIXTURE

(75) Inventor: Glen Gray, Heathrow, FL (US)

(73) Assignee: Motorola Solutions, Inc., Schaumburg, IL (US)

(21) Appl. No.: 12/980,289

(22) Filed: Dec. 28, 2010

(51) Int. Cl. H01Q 1/06; H01P 11/00

(52) U.S. Cl. 343/721; 29/600

(57) ABSTRACT

A method and apparatus for attaching an access point to a streetlight fixture is disclosed. A base unit of an access point is integrated to an inside face of a streetlight fixture connected to a top of a pole. An antenna of the access point is attached to an external portion of the streetlight fixture. The base unit and the antenna are connected with a wired connection so that information is transmitted and received at the base unit via the antenna.

### FIELD OF THE DISCLOSURE

The present disclosure relates generally to installing wireless communication devices and more particularly to integrating a wireless communication device into a streetlight fixture.

### BACKGROUND

A mesh network is a local area network (LAN) that employs either a full mesh topology connection arrangement or a partial mesh topology connection arrangement. In the full mesh topology, each node or connection point is connected directly to each of the other nodes in the network topology. A node is either a redistribution point, for example, an access point or a gateway, or an end point for data transmissions, for example a workstation, laptop or phone. In the partial mesh topology, some nodes may be connected to all the other nodes in the network topology, but some of the nodes are connected only to those other nodes with which they exchange the most data. The connections between nodes may be wired or wireless.

Deploying wireless mesh networks throughout a geographical area requires that wireless communication devices, such as access points, are affixed to attachment points. Each attachment point is expected to provide vertical elevation and power to a wireless communication device attached to the attachment point. A streetlight pole is an example of an attachment point to which a wireless communication device can be attached to provide network capabilities in a given location, such as a neighborhood. In some municipalities, decorative streetlights and poles are deployed in neighborhoods to complement the aesthetics of the neighborhood. Streetlight poles may be constructed with different materials, such as fiber glass or steel, and may be constructed such that there is no way to attach the wireless communication device directly to the pole. Accordingly, wireless communication devices may be attached to streetlight poles with standoff brackets. However, the weight of the wireless communication device and the weight of the bracket used to attach the wireless communication device to the pole may cause unacceptable torque on some poles, particularly poles constructed from thin materials, such as fiber glass. In addition, brackets used to attach the wireless communication device to the pole may distract from the aesthetics of the streetlight and may be objectionable to residents of a neighborhood.

Accordingly, there is a need for a method and apparatus for seamlessly integrating a wireless communication device into a streetlight fixture.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a wireless mesh network used in accordance with some embodiments.

FIG. 2A is a diagram of a standoff bracket used to attach an access point to a streetlight pole.

FIG. 2B is another diagram of a standoff bracket used to attach an access point to a streetlight pole.

FIG. 3 is a diagram of decorative streetlight poles to which an access point may be attached.

FIG. 4 is a block diagram of an access point which is configured to be integrated into a streetlight fixture in accordance with some embodiments.

FIG. 5 is a diagram of an access point integrated into a streetlight fixture in accordance with some embodiments.

FIG. 6 is a block diagram of brackets used to affix an antenna of an access point to a streetlight fixture in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Some embodiments are directed to apparatuses and methods for attaching an access point to a streetlight fixture. A base unit of an access point is integrated to an inside face of a streetlight fixture connected to a top of a pole. An antenna of the access point is attached to an external portion of the streetlight fixture. The base unit and the antenna are connected via a wired connection so that information is transmitted and received at the base unit via the antenna.

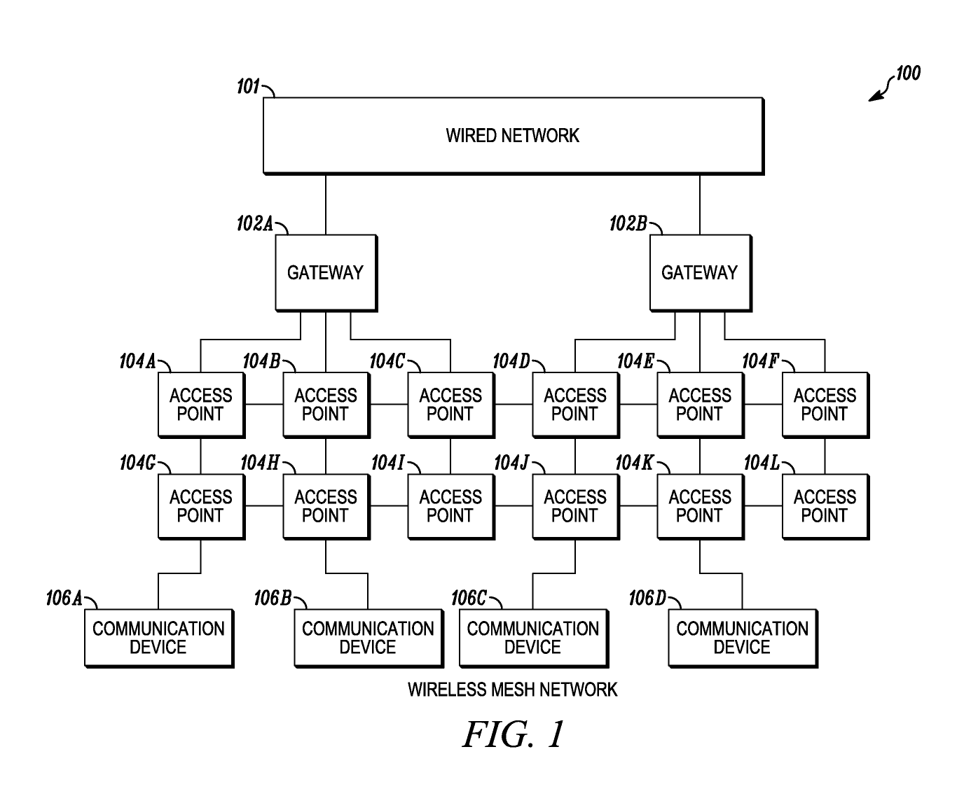

FIG. 1 is a block diagram of a wireless mesh network used in accordance with some embodiments. Wireless mesh network 100 includes one or more gateways 102A-102B that can be deployed to allow access to, for example, a wired network 101. Wireless mesh network 100 also includes access points 104A-104L which form a wireless backbone and provide connectivity in places otherwise difficult to access through traditional wired connections. Each access point 104A-104L includes wired or wireless capabilities and connects communication devices 106A-106D within wireless mesh network 100. In particular, communication devices 106A-106D, such as laptops, desktops, televisions, smart phones, and other devices with wireless capabilities, can access the network gateways 102A-102B by sending information through one or more access points 104A-104L. The access points support IEEE 802-11a, 802.11b, 802.11g, 802.11n or other similar wireless communication standards. (For any (IEEE) standards recited herein, contact the IEEE at IEEE, 445 Hoes Lane, PO Box 1331, Piscataway, N.J. 08855-1331, USA or see: http://standards.ieee.org/getieee802/index.html)

Because communication devices 106A-106D are connected to wireless mesh network 100 with redundant interconnections between access points 104A-104L, messages sent on wireless mesh network 100 can take any one of several possible paths from a source to a destination. For example, information may be transmitted from communication device 106A to gateway 102A through access points 104A and 104G. Information may also be transmitted from communication device 106A to gateway 102A through access points 104A, 104H and 104B. Therefore, when a connection between two nodes fails (for example when a connection between access points 104A and 104G fails), a message transmitted between communication device 106A and network gateway 102A may be sent through other access points, for example through access points 104A, 104H and 104B. It should be apparent to one skilled in the art that other components and configurations of wireless mesh network 100 are not shown for the sake of simplicity. It should be also noted that in some embodiments, gateways 102A-102B, access points 104A-104L and communication devices 106A-106D may be arranged in other network topologies, such as a star network topology, a ring network topology or a bus network topology. It should also be noted that wireless mesh network 100 may be used in conjunction with other topologies to form a hybrid topology.

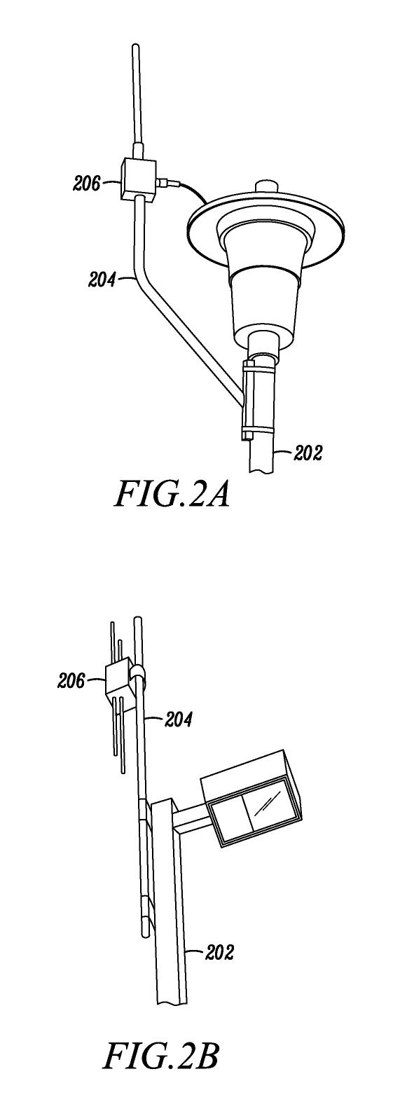

Access points 104A-104L are typically installed throughout a geographical area, such as a municipality, on attachment points. A pole such as a streetlight pole is an example of an attachment point to which an access point 104A-104L can be attached to provide network capabilities in a given location, such as a neighborhood. The streetlight pole provides vertical elevation and power for the attached access point. Streetlights poles may be constructed with different materials, such as steel or fiber glass, and may be designed to conform to specific aesthetics. Typically, each access point 104A-104L is attached to a streetlight pole with a standoff bracket, as shown in FIG. 2A and FIG. 2B. In FIG. 2A and FIG. 2B, an access point 206 is attached to streetlight pole 202 with bracket 204. Access point 206, as shown in FIG. 2A and FIG. 2B, may be the same as any of access points 104A-104L shown in FIG. 1. Depending on the construction material used for streetlight pole 202, some streetlight poles may fail to meet structural requirements associated with supporting the weight of bracket 204 and access point 206. Attaching brackets 204 to streetlight pole 202 may also distract from the aesthetics of streetlight pole 202.

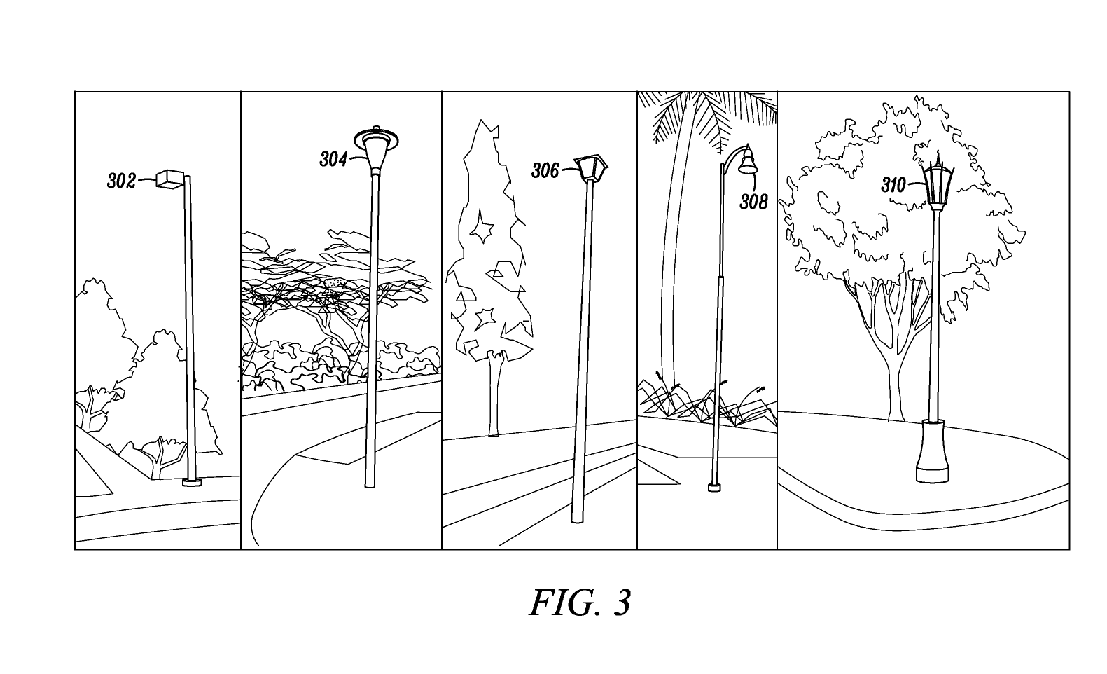

FIG. 3 is a diagram of streetlight poles to which an access point may be attached. Each of the streetlight poles 302-310 is constructed to meet predefined requirements, such as the total height of the streetlight pole and the weight of the base of the streetlight pole. As noted above, streetlight poles 302-310 may be constructed with different types of materials. As such, the weight support by one streetlight pole may not be supported by another streetlight pole. When a bracket, for example bracket 204, is used to attach the access point to any one of streetlight poles 302-310, the combined weight of the access point and the bracket 204 may not pass utility code structural requirements for poles made, for example, of thinner material such as fiberglass. Therefore, in some embodiments, the access point is configured to be integrated into a streetlight fixture.

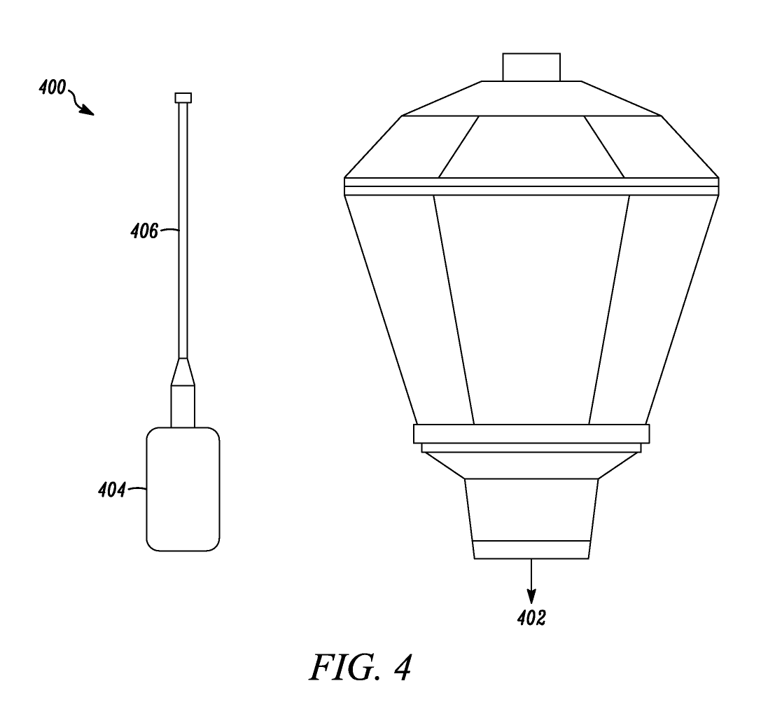

FIG. 4 is a block diagram of an access point which is configured to be integrated into a streetlight fixture in accordance with some embodiments. Access point 400 may be the same as any of access points 104A-104L shown in FIG. 1 or access point 206 shown in FIG. 2. Access point 400 includes a base unit 404 and at least one antenna 406 which is connected to base unit 404. Base unit 404 is configured to be integrated into a streetlight fixture 402 by, for example a screw, glue, a bracket, a hook, or other known attachment means. In particular, base unit 404 is attached to an inside face of streetlight fixture 402. When access point 400 is integrated with the internal portion/fact of streetlight fixture 402, because there is no need for a connection bracket, such as bracket 204, the deployed weight of access point 400 is likely to fall within utility code structural requirements. By integrating access point 400 directly into streetlight fixture 402, the weight of access point 400 may be deployed closer to a center line of the streetlight pole. This alignment reduces additional torque that is usually induced on a streetlight pole when the access point is installed with a bracket, such as bracket 204. In some embodiments, with the exception of antenna 406 extruding from streetlight fixture 402, no part of access point 400 is visibly attached to an external portion/face of the streetlight pole, thereby minimizing aesthetic objections to access points installed in this manner. In addition, any additional wind loading constraints of antenna 406 would be insignificant so that the installation of access point in streetlight fixture 402 is likely to fall within utility code structural requirements.

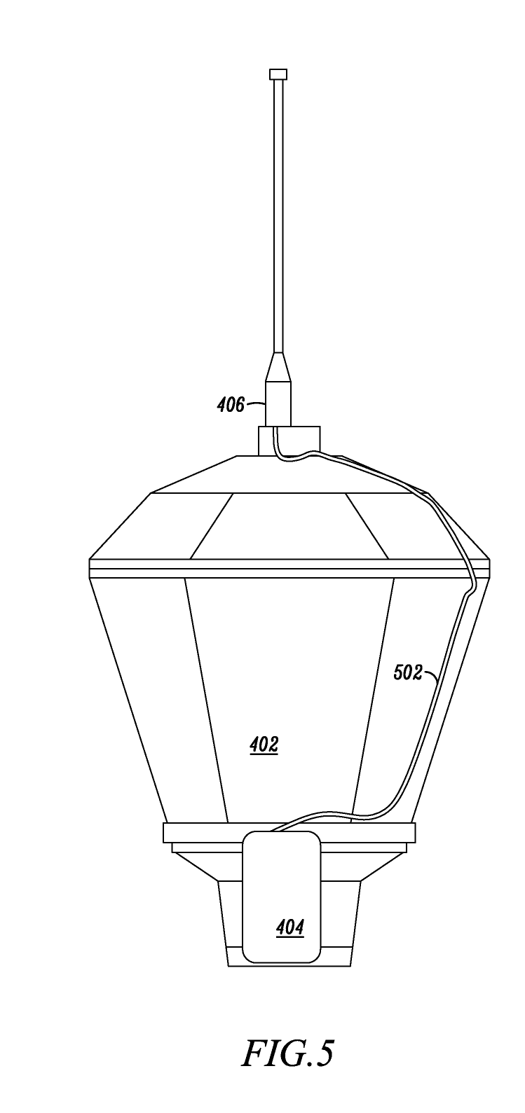

FIG. 5 is a diagram of an access point integrated into a streetlight fixture in accordance with some embodiments. In FIG. 5, a base of an access point is internally housed in streetlight fixture 402. Base unit 404 may be attached to any part of streetlight fixture 402 via known attachment means such as a screw or glue. A cable 502 connects base unit 404 of the access point to antenna 406 which protrudes from a hole in the top of streetlight fixture 402. It should be noted that antenna 406 may be installed on brackets attached to the top, sides, or beneath streetlight fixture 402. In some embodiments, antenna 406 is the only feature of access point 400 that is install outside of streetlight fixture 402.

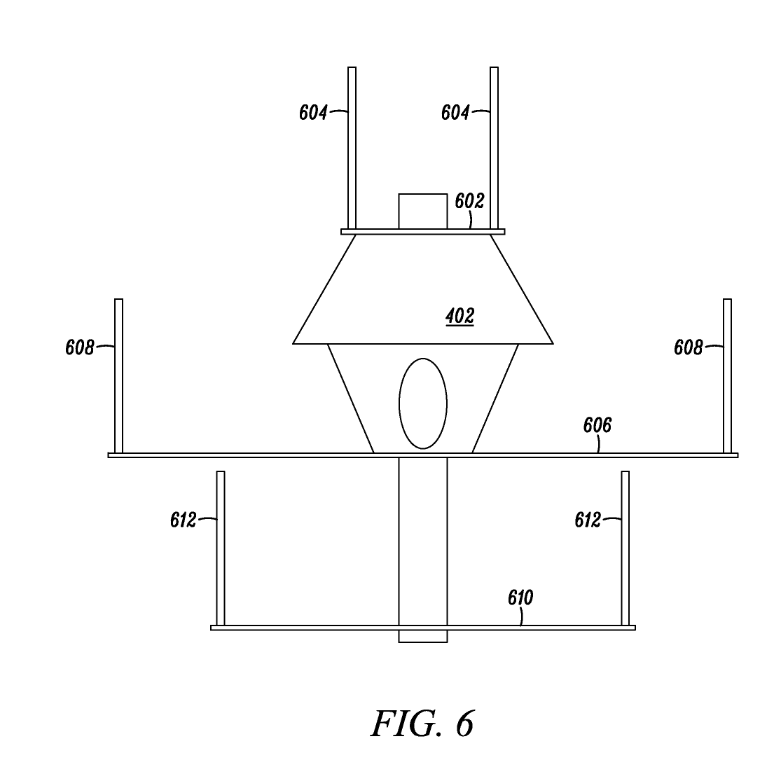

FIG. 6 is a block diagram of brackets used to attach an antenna of an access point to a streetlight fixture in accordance with some embodiments. A bracket 602 could be installed on the top of streetlight fixture 402. Antennas 604 are attached to bracket 602 and connected via cabling to an access point installed in streetlight fixture 402. In another example, a bracket 606 may be installed on the side of streetlight fixture 402 and antennas 608 may be attached to bracket 606 and connected via cabling to the access point installed in streetlight fixture 402. In another example, a bracket 610 may be installed on a pole beneath streetlight fixture 402 and antennas 612 may be attached to bracket 610 and connected via cabling to the access point installed in streetlight fixture 402. It should be apparent to one skilled in the art that other configurations for attaching antennas to streetlight fixture 402 are not shown for the sake of simplicity.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for attaching an access point to a streetlight fixture, comprising:
integrating a base unit of an access point to an inside face of a streetlight fixture connected to a top of a pole;
attaching an antenna of the access point to an external portion of the streetlight fixture; and
connecting the base unit and the antenna via a wired connection so that information is transmitted and received at the base unit via the antenna.

2. The method of claim 1, wherein the integrating the base unit comprises attaching the base unit of the access point to the internal portion of the streetlight fixture with at least one of a screw, glue, a bracket, or a hook.

3. The method of claim 1, wherein the integrating comprises attaching the base unit of the access point such that the weight of the access point is close to a center line of the pole.

4. The method of claim 1, wherein the attaching comprises attaching the antenna of the access point to the external portion of the streetlight fixture with a bracket.

5. The method of claim 4, further comprising attaching the bracket to a top, a side, or beneath the streetlight fixture.

6. An access point attached to a streetlight fixture, comprising:
a base unit integrated to an inside face of a streetlight fixture connected to a top of a pole;
an antenna attached to an external portion of the streetlight fixture; and
cabling for connecting the base unit and the antenna so that information is transmitted and received at the base unit via the antenna.

7. The access point of claim 6, wherein the base unit is integrated to the internal portion of the streetlight fixture with at least one of a screw, glue, a bracket, or a hook.

8. The access point of claim 6, wherein the base unit is integrated to the internal portion of the streetlight fixture such that the weight of the access point is close to a center line of the pole.

9. The access point of claim 6, wherein the antenna is attached to the external portion of the streetlight fixture with a bracket.

10. The access point of claim 6, wherein the antenna is attached to a top, a side, or beneath the streetlight fixture.
